(19) United States
(12) Patent Application Publication
(10) Pub. No.: US 2026/0212391 A1
(43) Pub. Date: Jul. 23, 2026

(54) PREDICTION OF PHYSICAL ART NUMERICAL REPRESENTATIONS USING MACHINE LEARNING

(71) Applicant: Appraisal Bureau, Inc., Atlanta, GA (US)

(72) Inventor: Caroline Davis Taylor, Atlanta, GA (US)

(21) Appl. No.: 19/456,612

(22) Filed: Jan. 22, 2026

Related U.S. Application Data
(60) Provisional application No. 63/748,359, filed on Jan. 22, 2025.

(51) Int. Cl. G06Q 30/02

(52) U.S. Cl. CPC G06Q 30/0278

(57) ABSTRACT

Described systems and methods evaluate physical artworks using machine learning. A physical art evaluation service receives a request for a numerical representation of a physical artwork. The request may include an image of the physical artwork. The physical art evaluation service obtains electronic asset data describing the physical artwork and inputs the asset data to a machine learning model. The machine learning model is trained on historical numerical representations paired with electronic asset data describing a set of physical artworks. The physical art evaluation service receives an estimated numerical representation for the physical artwork and triggers notifications regarding the numerical representation to one or more accounts associated with the physical artwork.

### CROSS-REFERENCE TO RELATED APPLICATIONS

This application claims the benefit of U.S. Provisional Application 63/748,359, filed on Jan. 22, 2025, which is incorporated by reference in its entirety.

### BACKGROUND

### 1. Field

This disclosure relates generally to machine learning, and more specifically to determining numerical representations for physical art.

### 2. Description of the Related Art

Evaluation of physical art is often subjective and can vary significantly based on numerous factors. These factors may include an artist's reputation, a physical artwork's age and condition, the relevance or importance of the physical artwork in the artist's career, the physical artwork's provenance, exchanges of comparable physical artworks, art exchange trends, and so on. Some of this data may be non-transparent and only privately accessible. For example, while some results are often published, galleries—which make up the bulk of the physical art exchange—are not required to disclose information about exchanges to a centralized source. Such data opacity makes forming accurate predictions of numerical representations for physical art error prone and inaccurate.

### SUMMARY

Described herein are systems and methods for providing physical art evaluations via an application that maintains third-party neutral data. The platform stores data relating to physical artworks that may be traded publicly and/or privately, such that previously unavailable data may be used to facilitate fair exchanges of physical artworks. The data includes standardized fields relevant to physical artworks, such as artists, title, dimension, material, year of creation, etc. and one or more images of the physical artwork. The platform can leverage the data to estimate a numerical representation for a physical artwork, which may be used as an evaluation for the physical artwork. The evaluation may be necessary or requested for an exchange of the physical artwork from one holder to another to occur. The platform stores data describing these exchanges, and the physical artworks themselves, such that the platform may use the data to inform further numerical representation estimations.

The features and advantages described in the specification are not all inclusive and, in particular, many additional features and advantages will be apparent to one of ordinary skill in the art in view of the drawings and specification. Moreover, it should be noted that the language used in the specification has been principally selected for readability and instructional purposes, and may not have been selected to delineate or circumscribe the inventive subject matter.

### BRIEF DESCRIPTION OF THE DRAWINGS

FIG. 1 is a block diagram of an overall system environment illustrating physical art evaluation service, according to an embodiment.

FIG. 2A is an example user interface for receiving asset data, according to one embodiment.

FIG. 2B is an example user interface that depicts a portfolio of physical artworks, according to one embodiment.

FIG. 2C is an example user interface depicting asset data for a physical artwork in a portfolio, according to one embodiment.

FIG. 3 is a high-level block diagram of a computer for implementing different entities illustrated in FIG. 1.

FIG. 4 is a flowchart of an example process for triggering one or more notifications in response to receiving an estimated numerical representation, according to one embodiment.

### DETAILED DESCRIPTION

The Figures and the following description relate to various embodiments by way of illustration only. It should be noted that from the following discussion, alternative embodiments of the structures and methods disclosed herein will be readily recognized as viable alternatives that may be employed without departing from the principles discussed herein. Reference will now be made in detail to several embodiments, examples of which are illustrated in the accompanying figures. It is noted that wherever practicable similar or like reference numbers may be used in the figures and may indicate similar or like functionality.

### System Overview

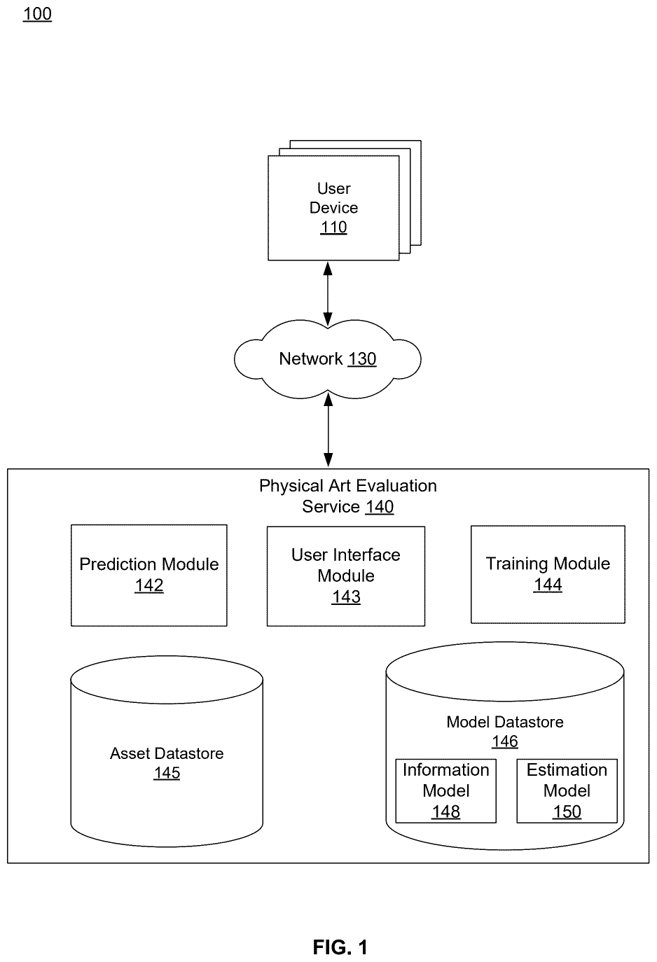

FIG. 1 is a block diagram of an overall system environment 100 illustrating a physical art evaluation service 140, according to an embodiment. The physical art evaluation service 140 uses machine learning models to determine electronic asset data (referred to for convenience below as asset data or electronic data) for physical artworks, including numerical representations of the artworks. The physical art evaluation service 140 provides user interfaces that allow users to receive asset data for physical artworks, browse portfolios, and request estimations of numerical representations for physical artworks. The user interfaces also allow users request and receive notifications regarding changes in asset data of selected physical artworks.

As shown in FIG. 1, the overall system environment includes the physical art evaluation service 140, one or more user devices 110, and a network 130. Other embodiments may use more or fewer or different systems than those illustrated in FIG. 1. Functions of various modules and systems described herein can be implemented by other modules and/or systems than those described herein. Further, though the following description pertains to physical artworks (e.g., paintings, sculptures, ceramics, etc.), in some embodiments, the physical art evaluation service may be used to determine and store asset data for other types of assets, such as trading cards, designer clothing, vintage watches, antique furniture, vintage cars, wine and spirits, and other collectibles or memorabilia.

A user device 110 (also referred to as a client device) is a computing system used by users to interact with the physical art evaluation service 140. A user interacts with the physical art evaluation service 140 using a user device 110 that executes client software, e.g., a web browser or a client application, to connect to the physical art evaluation service 140. The user device 110 displayed in these embodiments can include, for example, a mobile device (e.g., a laptop, a smart phone, or a tablet with operating systems such as Android, Apple iOS, etc.), a desktop, smart automobiles or other vehicles, wearable devices, a smart TV, and other network-capable devices. The user device 110 can present physical artwork portfolios and asset data provided by the physical art evaluation service 140.

The network 130 facilitates communication between the user devices 110 and the physical art evaluation service 140. The network 130 is typically the Internet, but may be any network, including but not limited to a local area network (LAN), a metropolitan area network (MAN), a wide area network (WAN), a mobile wired or wireless network, a cloud computing network, a private network, or a virtual private network.

The physical art evaluation service 140 includes a prediction module 142, a training module 144, a user interface module 143, an asset datastore 145, and a model datastore 146, all of which are further described below. Other conventional features of the physical art evaluation service 140, such as firewalls, load balancers, authentication servers, application servers, failover servers, and site management tools are not shown so as to more clearly illustrate the features of the physical art evaluation service 140. The illustrated components of the physical art evaluation service 140 can be implemented as single or multiple components of software or hardware. In general, functions described in one embodiment as being performed by one component can also be performed by other components in other embodiments, or by a combination of components. Furthermore, functions described in one embodiment as being performed by components of the physical art evaluation service 140 can also be performed by one or more user devices 110 in other embodiments if appropriate.

In various embodiments, the physical art evaluation service 140 includes one or more machine learning models that operate together to generate electronic asset data for physical artworks. These machine learning models may include an information model 148 and an estimation model 150. The information model 148 analyzes input imagery or other raw inputs to determine descriptive electronic asset data for an artwork. The estimation model 150 consumes the electronic asset data generated by the information model (and optionally comparable artwork data) to predict a numerical representation associated with the artwork. Collectively, these machine learning models form a machine-learning subsystem stored within the model datastore 146 and executed by the prediction module 142.

The prediction module 142 receives requests to determine asset data from the user interface module 143. Asset data includes traits and features describing or associated with a particular physical artwork such as desirability of composition, color, rarity or condition of a physical artwork. These factors vary for each artist and often for specific series of physical artworks within an artist's oeuvre. Asset data further indicates characteristics and descriptions of a physical artwork. For example, asset data may include an artist name, artwork title, medium, category (modern, abstract, surrealist, cubist, etc.), date of creation, edition/version, condition (poorly kept, well kept, etc.), and the like.

In various embodiments, a request for asset data includes an image of a physical artwork and may include a subset of the asset data for the physical artwork, which, for example, may have been manually included in the request. The prediction module 142 inputs the image and any included asset data to an information model 148 stored at the model datastore 146. The information model 148 is a machine learning model, such as a classifier, neural network, or transformer, capable of analyzing an image to determine asset data describing the physical artwork in the image. The information model 148 is trained by the training module 144, as further described below.

The prediction module 142 receives asset data from the information model 148 and stores the asset data in association with the physical artwork in an asset datastore 145. For instance, the prediction module 142 may store an identifier of the physical artwork (for simplicity, referred to as the physical artwork herein) in association with the image and asset data. The prediction module 142 may associate the physical artwork with comparable physical artworks stored at the asset datastore 145. Each comparable physical artwork shares at least one characteristic (e.g., similar asset data) with the physical artwork. For example, a comparable physical artwork may be associated with the same category, have similar dimensions, and/or have a date of creation to the physical artwork. In some embodiments, the prediction module 142 receives indications of comparable physical artworks from the user interface module and stores the comparable physical artworks in association with the physical artwork in the asset datastore 145.

The prediction module 142 may also associate the physical artwork with an account of a user that submitted the request and may store other accounts representing interested parties of the physical artwork in association with the physical artwork in the asset datastore. For example, the prediction module 142 may receive requests to associate one or more accounts as a current possessor of the physical artwork, a potential possessor of the physical artwork (e.g., someone who would like to acquire the physical artwork), or a subscriber of the physical artwork (e.g., an interested party who would like to receive updates when the physical artwork is exchanged or its asset data is updated). The requests may also indicate for the prediction module 142 to take action based on one or more triggering conditions. Triggering conditions may include asset data changing or the physical artwork being exchanged. In some embodiments, a triggering condition may be associated with a threshold or range. For example, a triggering condition may be the prediction module 142 estimating a numerical representation for the physical artwork that is within a specified range. In another example, a triggering condition may be the prediction module 142 dissociating a threshold number of accounts from the physical artwork in the asset datastore 145. Examples of actions include the prediction module 142 sending notifications to one or more accounts, associating or dissociating accounts with the physical artwork in the asset datastore 145, updating asset data related to the physical artwork, etc.

The prediction module 142 also estimates numerical representations for physical artworks. A numerical representation quantifies the desirability, attractiveness, and/or demand for possessing a physical artwork and may be, for example, a normalized score, an ordinal grade (e.g., 1-10), or another indication of value. In various embodiments, the numerical representation may indicate a quantity an individual is willing to exchange to achieve possession of the physical artwork. In some embodiments, the numerical representation is a grade or other classification that indicates a condition of the physical artwork (e.g., how standardized, authentic, etc. the physical artwork is). The prediction module 142 may receive requests from the user interface module 143 for an estimated numerical representation. The prediction module 142 may also be configured to estimate a numerical representation based on a triggering condition/event or at set time intervals.

The prediction module 142 retrieves asset data related to the physical artwork from the asset datastore 145 and inputs the asset data to an estimation model 150. The estimation model 150 is a machine learning model, such as a classifier, neural network, or transformer, capable of predicting a numerical representation for a physical artwork based on asset data. In some embodiments, the estimation model 150 includes a large language model (LLM) trained to generate text describing a numerical representation and/or aspects of the physical artwork that may be used to determine the numerical representation. For example, the estimation model 150 may include two sub-models, one of which is the LLM. The estimation model 150 may apply the LLM to generate text summarizing aspects of the physical artwork that are relevant to estimating a numerical representation and input the text to the second sub-model, which predicts a numerical representation. In some embodiments, the prediction module 142 also accesses asset data related to comparable physical artworks of the physical artwork and inputs the asset data to the estimation model 150 for the prediction. The estimation model 150 is trained by the training module 144, as is further described below.

The prediction module 142 receives an estimated numerical representation from the estimation model 150. For example, an estimated numerical representation may be a monetary value for the physical artwork, a grade of the physical artwork, a popularity rating of the physical artwork, and the like. The prediction module 142 sends the estimated numerical representation to the user interface module 143 and stores the estimated numerical representation in the asset datastore 145 in association with the physical artwork. In some embodiments, the prediction module 142 creates a new version of the asset data for the physical artwork in the asset datastore 145, where the new version includes the estimated numerical representation, the asset data input to the estimation model 150 for the estimation, and a time/date of the estimation. Each physical artwork may be associated with multiple versions in the asset datastore 145.

The user interface module 143 causes user devices 110 to display user interfaces that depict asset data from the asset datastore 145. The user interface module 143 receives interactions entered at the user interfaces and takes action based on the interactions. Interactions may include requests to view particular asset data, requests to receive an estimated numerical representation, requests to update asset data, and the like. For example, the user interface module 143 may receive a request to add a physical artwork to the asset datastore. The user interface module 143 causes the associated user device 110 to display a set of interactive elements configured to receive an image of the physical artwork and asset data for the physical artwork. The user interface module 143 sends the image and any asset data to the prediction module 142. The user interface module 143 causes the user device 110 to display asset data received from the prediction module 142 and may receive interactions indicative of verdicts about the asset data from the user device 110. A verdict indicates whether the user approves of or rejects a portion (or all) of the asset data. For example, a user may input a verdict that an artist described by the asset data is not the artist who created the physical artwork. The user interface module 143 may request new asset data from the prediction module 142 in response and stores the verdicts in association with the asset data in the asset datastore.

The user interface module 143 also sends estimated numerical representation for display at user devices 110. For instance, the user interface module 143 may receive an interaction from a user device 110 indicating a request for an estimated numerical representation of a physical artwork. The user interface module 143 requests the numerical representation from the prediction module 142 and sends the numerical representation to the user device 110 for display with one or more interactive elements configured to receive a verdict for the numerical representation. A verdict indicates whether the user approves of or rejects the numerical representation for the physical artwork. For example, the user may be an evaluator and determine that the numerical representation is or is not a fair representation of the desirability of the physical artwork. The user interface module 143 may request a new estimated numerical representation from the prediction module 142 in response to receiving a rejection and send the rejection with the request to the prediction module 142. In some embodiments, the rejection includes a textual description of asset data or comparable physical artworks for the prediction module 142 to consider (e.g., include in its input to the estimation model 150) in generating a new numerical representation. The user interface module 143 stores verdicts in association with the estimated numerical representation in the asset datastore.

In various embodiments, the training module 144 trains the information model 148 and the estimation model 150. For the information model 148, the training module 144 retrieves images of physical artworks stored at the asset datastore 145. The training module 144 labels each image with its associated asset data and inputs the labeled images to the information model 148 for training. In some embodiments, the training module 144 also labels a subset of the asset data with a verdict stored in association with the subset. The training module 144 may store the labeled images as training data in the asset datastore 145 and add to the training data when new images are stored at the asset datastore 145. The training module 144 may retrain the information model 148 at set intervals or in response to a triggering condition.

In various embodiments, the training module 144 also trains the estimation model 150. The training module 144 accesses numerical representations in the asset data store. The training module 144 may label each numerical representation with a source that determined the numerical representation, such as an evaluator or an exchange of the physical artwork. In some embodiments, the training module 144 also labels the numerical representation with an associated verdict. The training module 144 further labels each numerical representation with associated asset data. In some embodiments, multiple numerical representations may be associated with the same physical artwork. The training module 144 inputs the labeled numerical representations to the estimation model 150 for training. The training module 144 may store the labeled numerical representations as training data in the asset datastore 145 and add to the training data when new numerical representations are estimated or otherwise received, such as when a physical artwork is exchanged. The training module 144 may retrain the estimation model 150 at set intervals or in response to a triggering condition.

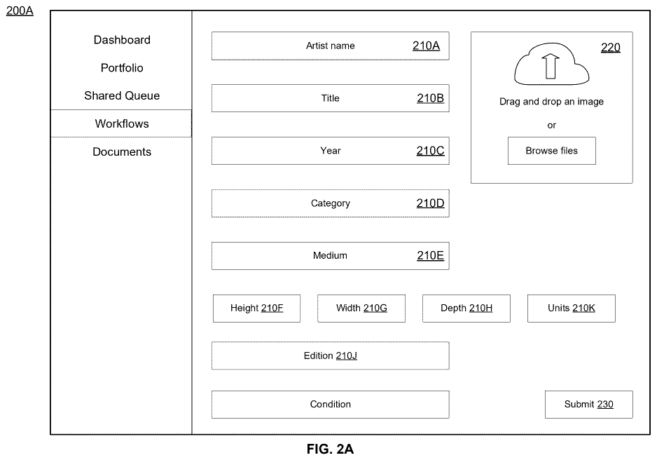

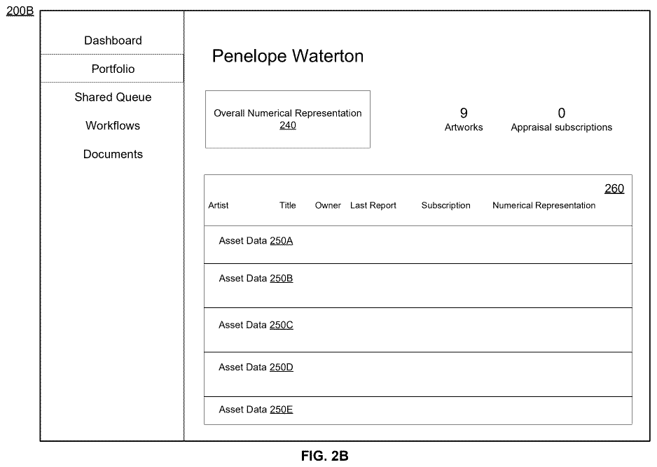

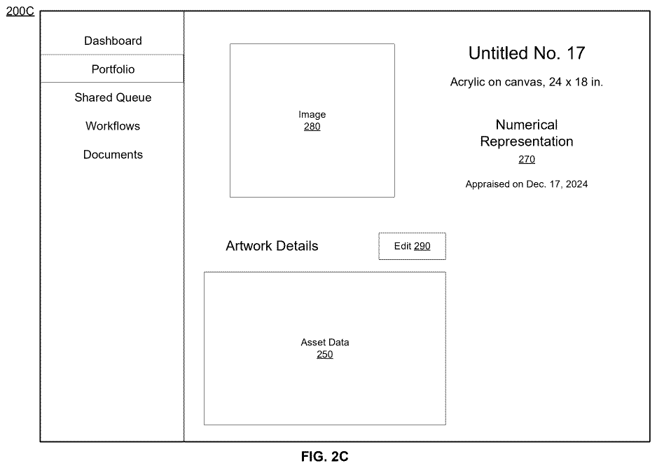

FIG. 2A is an example user interface 200A for receiving asset data, according to one embodiment. The user interface module 143 may cause a user device 110 to display the user interface 200A in response to receiving an indication that a user wants to add a physical artwork to the physical art evaluation service 140. The user interface 200A includes a plurality of text boxes 210 configured to receive asset data entered manually by a user and an image element 220 configured to receive an image of a physical artwork. In some embodiments, the user interface 200A includes other interactive elements (e.g., drop-down menus, checkboxes, etc.) that are configured to receive asset data. In response to receiving an interaction with a submission element 230, the user interface 200A may update to include asset data determined by the information model 148 in the text boxes 210.

FIG. 2B is an example user interface 200B that depicts a portfolio of physical artworks, according to one embodiment. The user interface module 143 may cause a user device 110 to display the user interface 200B in response to receiving a request to view an account's portfolio. A portfolio is a grouping of physical artworks associated with a user of the account (e.g., “Penelope Waterton”), such as a user that fully or partly owns the physical artwork or a user that maintains a portfolio of physical artworks they are interested in. For example, the portfolio may include physical artworks that the user “subscribed,” thus allowing the user to receive updates related to the physical artwork when asset data is changed or added. The user interface 200B may include an overall numerical representation 240 of the portfolio, which is a sum of the estimated numerical representations of each of the physical artworks in the portfolio. The user interface 200B also includes a table 260 of physical artworks in the portfolio, where each physical artwork is represented by a row of asset data 250 in the table. The user interface 200B may be configured to receive interactions allowing a user to scroll through the rows of the table 260, select a physical artwork to view more asset data of the physical artwork, request a new estimation of the numerical representation 240, indicate that the user is willing to exchange the physical artwork, and the like.

FIG. 2C is an example user interface 200C depicting asset data for a physical artwork in a portfolio, according to one embodiment. The user interface module 143 may cause a user device 110 to display the user interface 200C in response to receiving a request to view a particular physical artwork of an account's portfolio. The user interface 200C may include a numerical representation 270 of the physical artwork, which may be estimated in response to receiving the request or may be based on a most recent exchange of the physical artwork. The user interface 200C also includes asset data 250 related to the physical artwork and an image 280 of the physical artwork. The image may be a photograph of the physical artwork or a digital rendering of the physical artwork created from a three-dimensional scan of the physical artwork. The user interface 200C includes an edit button 290 that a user can interact with to indicate a desire to modify asset data associated with the physical artwork.

### Computer Architecture

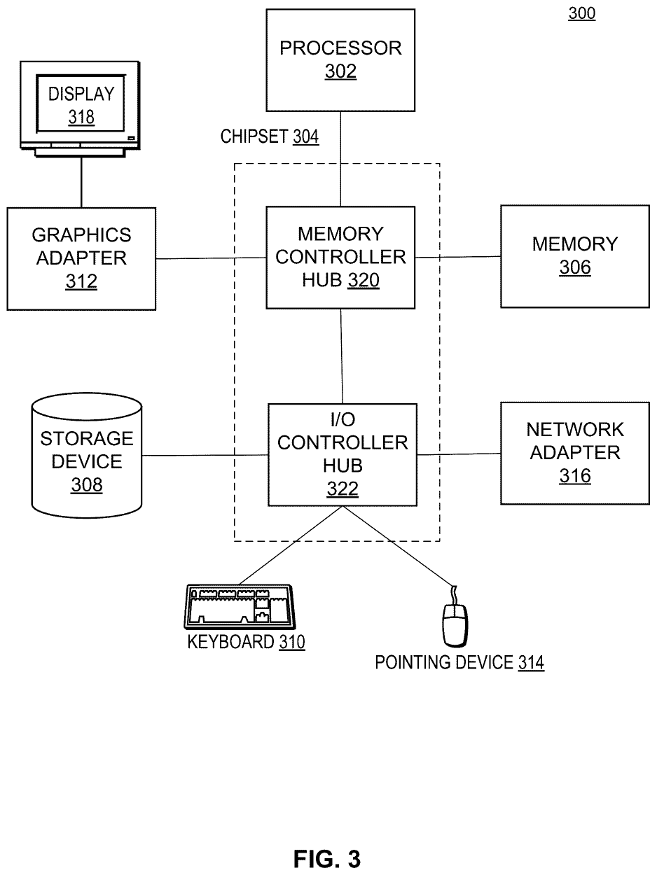

FIG. 3 is a high-level block diagram of a computer 300 for implementing different entities illustrated in FIG. 1. The computer 300 includes at least one processor 302 coupled to a chipset 304. Also coupled to the chipset 304 are a memory 306, a storage device 308, a keyboard 310, a graphics adapter 312, a pointing device 314, and a network adapter 316. A display 318 is coupled to the graphics adapter 312. In one embodiment, the functionality of the chipset 304 is provided by a memory controller hub 320 and an I/O controller hub 322. In another embodiment, the memory 306 is coupled directly to the processor 302 instead of the chipset 304.

The storage device 308 is any non-transitory computer-readable storage medium, such as a hard drive, compact disk read-only memory (CD-ROM), DVD, or a solid-state memory device. The memory 306 holds instructions and data used by the processor 302. The pointing device 314 may be a mouse, track ball, or other type of pointing device, and is used in combination with the keyboard 310 to input data into the computer system 300. The graphics adapter 312 displays images and other information on the display 318. The network adapter 316 couples the computer system 300 to the network 130.

As is known in the art, a computer 300 can have different and/or other components than those shown in FIG. 3. In addition, the computer 300 can lack certain illustrated components. For example, the computer acting as the physical art evaluation service 140 can be formed of multiple blade servers linked together into one or more distributed systems and lack components such as keyboards and displays. Moreover, the storage device 308 can be local and/or remote from the computer 300 (such as embodied within a storage area network (SAN)).

As is known in the art, the computer 300 is adapted to execute computer program modules for providing functionality described herein. As used herein, the term “module” refers to computer program logic utilized to provide the specified functionality. Thus, a module can be implemented in hardware, firmware, and/or software. In one embodiment, program modules are stored on the storage device 308, loaded into the memory 306, and executed by the processor 302.

### Example Method

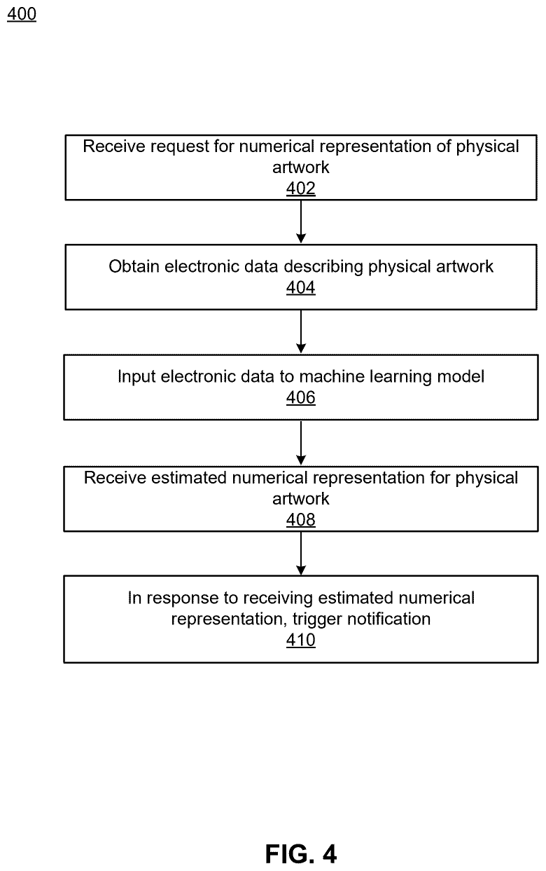

FIG. 4 is a flowchart illustrating an example process 400 for triggering one or more notifications in response to receiving an estimated numerical representation, according to one embodiment. Though described in relation to the physical art evaluation service 140, the example process 400 may be performed by additional or alternative modules, such as computer 300. Further, the example process may include additional or alternative steps to those shown in FIG. 4.

The physical art evaluation service 140 receives 402 a request for a numerical representation of a physical artwork. The request includes a photograph of the physical artwork and may include other input data describing the physical artwork, such as a title, dimensions, current owner, etc. The physical art evaluation service 140 obtains 404 electronic asset data describing the physical artwork. In some embodiments, the physical art evaluation service 140 applies an information model 148 to the image and/or input data to determine electronic asset data describing the physical artwork. The asset data may include the input data and may describe physical and non-physical characteristics of the physical artwork, such as artist, medium, date of creation, etc. In some embodiments, the physical art evaluation service 140 obtains the asset data of the physical artwork by accessing a data structure (such as asset datastore 145) that stores physical artworks in association with asset data and accounts of owners, interested parties, and the like.

The physical art evaluation service 140 inputs 406 the asset data to an estimation model 150. The estimation model 150 is a machine learning model trained to estimate a numerical representation for the physical artwork. For example, the estimation model 150 may determine that a first physical artwork by an artist is associated with a higher numerical representation than a second physical artwork by an artist in part because the artist's physical artworks are, on average, exchanged for higher values when the physical artworks are blue than when the physical artworks are red. The estimation model 150 is trained on historical asset data of a set of physical artworks, each labeled with a numerical representation associated with the respective physical artwork. The physical art evaluation service 140 receives 408, as output from the estimation model 150, an estimated numerical representation for the physical artwork. In response, the physical art evaluation service 140 triggers 410 a notification regarding the numerical representation to accounts associated with the physical artwork.

In some embodiments, the physical art evaluation service 140 causes a user interface at a user device 110 to display asset data related to the physical artwork. In response to receiving an indication from the user interface, the physical art evaluation service 140 removes a connection between a first account of the accounts and the physical artwork and maintains connections between the other accounts and the physical artwork in the data structure. In some embodiments, the physical art evaluation service 140 causes the user interface to display asset data of comparable physical artworks to the physical artworks. For example, the data structure may store connections between the physical art and comparable physical artworks, such as a second physical artwork. The physical artwork may share at least one characteristic with each of the comparable physical artworks. In response to storing new asset data in relation to the second physical artwork, the physical art evaluation service 140 sends a notification describing the new asset data to the accounts associated with the physical artwork.

In some embodiments, the physical art evaluation service 140 may receive requests to display estimated numerical representations of comparable physical artworks of the physical artwork. The physical art evaluation service 140 may send asset data and an associated estimated numerical representation for each comparable physical artwork to a user device 110 associated with the request. The physical art evaluation service 140 may cause the user device 110 to display each comparable physical artwork and associated estimated numerical representation with interactive elements that allow a user of the user device 110 to input a verdict for the estimated numerical representation. For example, an interaction with a first interactive element may indicate that the user approved of the estimated numerical representation for the comparable physical artwork. An interaction with a second interactive element may indicate that the user rejected the estimated numerical representation for the comparable physical artwork. An interaction with a third interactive element may indicate that the user does not find the comparable physical artwork to be comparable to the physical artwork. The physical art evaluation service 140 may store indications for these verdicts along with each associated comparable physical artwork to be used as training data for the estimation model 150. The physical art evaluation service 140 may also update connections between the physical artwork and comparable physical artworks based on the interactions.

In some embodiments, the physical art evaluation service 140 trains the information model 148 on images of physical artworks labeled with asset data, such as an artist who creates the physical artwork. The physical art evaluation service 140 may use the information model 148 to generate asset data for physical artworks upon request or automatically in response to storing the physical artwork in the data structure.

In some embodiments, the physical art evaluation service 140 receives requests for accounts to receive notifications in response to changes in asset data related to the physical artwork. For example, the physical art evaluation service 140 may store the estimated numerical representation as asset data for the physical artwork. Based on a previous request from an interested party to receive a notification if the estimated numerical representation of the physical artwork changes to be within a specified range, the physical art evaluation service 140 may send a notification to a mobile device associated with the account of the interested party.

### Alternative Embodiments

The features and advantages described in the specification are not all inclusive and in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

It is to be understood that the figures and descriptions have been simplified to illustrate elements that are relevant for a clear understanding of the present invention, while eliminating, for the purpose of clarity, many other elements found in a typical online system. Those of ordinary skill in the art may recognize that other elements and/or steps are desirable and/or required in implementing the embodiments. However, because such elements and steps are well known in the art, and because they do not facilitate a better understanding of the embodiments, a discussion of such elements and steps is not provided herein. The disclosure herein is directed to all such variations and modifications to such elements and methods known to those skilled in the art.

Some portions of above description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the various embodiments. This description should be read to include one or at least one and the singular also includes the plural unless it is obvious that it is meant otherwise.

Upon reading this disclosure, those of skill in the art will appreciate still additional alternative designs for a unified communication interface providing various communication services. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

I claim:

1. A method comprising:
receiving a request for a numerical representation of a physical artwork, the request including a photograph of the physical artwork;
obtaining electronic data describing the physical artwork;
inputting, to a machine learning model, the electronic data, wherein the machine learning model is trained on historical electronic data of a set of artworks labeled with a numerical representation associated with the respective artwork;
receiving, from the machine learning model as output, an estimated numerical representation for the physical artwork; and
in response to receiving the estimated numerical representation, triggering one or more notifications regarding the numerical representation to one or more accounts associated with the physical artwork.

2. The method of claim 1, wherein the one or more accounts are stored in a data structure in association with a plurality of artworks, the method further comprising:
in response to receiving an indication from a user interface, removing a connection between a first account of the one or more accounts and the physical artwork, wherein the first account maintains a connection with a second physical artwork.

3. The method of claim 1, wherein the one or more accounts are stored in a data structure in association with a plurality of artworks, the method further comprising:
in response to storing new data in relation to a second physical artwork, the physical artwork and the second physical artwork associated in the data structure as comparable artworks, sending a notification to the one or more accounts associated with the physical artwork, wherein the notification describes the new data.

4. The method of claim 1, further comprising:
retrieving, from a data structure storing accounts in association with artworks, one or more comparable artworks to the physical artwork, wherein the physical artwork shares at least one characteristic with each of the comparable artworks;
sending the one or more comparable artworks and associated estimated numerical representations to a mobile device associated with an evaluator;
receiving, from each of the one or more comparable artworks, a verdict for the estimated numerical representation, wherein the verdict indicates the evaluator's approval or rejection of the estimated numerical representation; and
training the machine learning model on the one or more comparable artworks labeled with its associated estimated numerical representation and verdict.

5. The method of claim 1, further comprising:
training a second machine learning model on photographs of artworks labeled with one or more artists who created a respective artwork;
inputting, to the second machine learning model, the photograph of the physical artwork; and
receiving an identifier of an artist predicted to have created the physical artwork.

6. The method of claim 1, further comprising:
receiving, from an account of an interested party, a request to receive a notification if the estimated numerical representation of the physical artwork is within a range; and
in response to the estimated numerical representation being within the range, sending the notification to a mobile device associated with the account of the interested party.

7. The method of claim 1, wherein obtaining electronic data describing the physical artwork comprises:
receiving, via a user interface, the photograph of the physical artwork;
inputting the photograph of the physical artwork to a second machine learning model;
receiving, from the second machine learning model, the electronic data describing the physical artwork;
transmitting the electronic data describing the physical artwork for display via the user interface;
in response to receiving a modification of the electronic data via the user interface, adding the photograph labeled with the modified electronic data to a set of training data; and
training the second machine learning model using the training data.

8. A computer program product stored on a non-transitory computer readable medium, the computer program product including executable code that when executed by one or more processors causes the processor to perform steps comprising:
receiving a request for a numerical representation of a physical artwork, the request including a photograph of the physical artwork;
obtaining electronic data describing the physical artwork;
inputting, to a machine learning model, the electronic data, wherein the machine learning model is trained on historical electronic data of a set of artworks labeled with a numerical representation associated with the respective artwork;
receiving, from the machine learning model as output, an estimated numerical representation for the physical artwork; and
in response to receiving the estimated numerical representation, triggering one or more notifications regarding the numerical representation to one or more accounts associated with the physical artwork.

9. The computer program product of claim 8, wherein the one or more accounts are stored in a data structure in association with a plurality of artworks, and further comprising:
in response to receiving an indication from a user interface, removing a connection between a first account of the one or more accounts and the physical artwork, wherein the first account maintains a connection with a second physical artwork.

10. The computer program product of claim 8, wherein the one or more accounts are stored in a data structure in association with a plurality of artworks, and further comprising:
in response to storing new data in relation to a second physical artwork, the physical artwork and the second physical artwork associated in the data structure as comparable artworks, sending a notification to the one or more accounts associated with the physical artwork, wherein the notification describes the new data.

11. The computer program product of claim 8, further comprising:
retrieving, from a data structure storing accounts in association with artworks, one or more comparable artworks to the physical artwork, wherein the physical artwork shares at least one characteristic with each of the comparable artworks;
sending the one or more comparable artworks and associated estimated numerical representations to a mobile device associated with an evaluator;
receiving, from each of the one or more comparable artworks, a verdict for the estimated numerical representation, wherein the verdict indicates the evaluator's approval or rejection of the estimated numerical representation; and
training the machine learning model on the one or more comparable artworks labeled with its associated estimated numerical representation and verdict.

12. The computer program product of claim 8, further comprising:
training a second machine learning model on photographs of artworks labeled with one or more artists who created a respective artwork;
inputting, to the second machine learning model, the photograph of the physical artwork; and
receiving an identifier of an artist predicted to have created the physical artwork.

13. The computer program product of claim 8, further comprising:
receiving, from an account of an interested party, a request to receive a notification if the estimated numerical representation of the physical artwork is within a range; and
in response to the estimated numerical representation being within the range, sending the notification to a mobile device associated with the account of the interested party.

14. The computer program product of claim 8, wherein obtaining electronic data describing the physical artwork comprises:
receiving, via a user interface, the photograph of the physical artwork;
inputting the photograph of the physical artwork to a second machine learning model;
receiving, from the second machine learning model, the electronic data describing the physical artwork;
transmitting the electronic data describing the physical artwork for display via the user interface;
in response to receiving a modification of the electronic data via the user interface, adding the photograph labeled with the modified electronic data to a set of training data; and
training the second machine learning model using the training data.
